(19) United States
(12) Patent Application Publication
(10) Pub. No.: US 2026/0091451 A1
(43) Pub. Date: Apr. 2, 2026

(54) HYBRID BUILDING SYSTEM

(71) Applicants: Donald Lee Deptowicz, Berthoud, CO (US); Ronald Joseph, Jensen Beach, FL (US)

(72) Inventors: Donald Lee Deptowicz, Berthoud, CO (US); Ronald Joseph, Jensen Beach, FL (US)

(21) Appl. No.: 19/113,029

(22) PCT Filed: Sep. 21, 2023
(86) PCT No.: PCT/US2023/033335

§ 371 Date: Mar. 19, 2025

Related U.S. Application Data
(60) Provisional application No. 63/408,708, filed on Sep. 21, 2022.

(51) Int. Cl. B23K 26/40; B23K 103/04; B33Y 80/00; C04B 14/02; C04B 111/00; E04B 1/64; E04C 5/01

(52) U.S. Cl. CPC B23K 26/40; B33Y 80/00; C04B 14/022; E04B 1/642; E04C 5/015; B23K 2103/04; C04B 2111/00181; C04B 2111/00525

(57) ABSTRACT

A method for coating a structural element includes laser ablating a structural element to remove surface contamination; applying a graphene-enhanced coating to the structural element; and encasing the structural element in a graphene-enhanced primary building material.

This application claims the priority benefit of U.S. Provisional Application No. 63/408,708, filed Sep. 21, 2022, and titled “HYBRID BUILDING SYSTEM,” which is incorporated by reference in its entirety.

### BACKGROUND

Although concrete is used in construction projects of greatly varying scopes on both land and sea, it is susceptible to the negative impacts of nature such as rain, salt, wind, and seasonal temperature changes. Structural steel used in current concrete building systems is contaminated with residual chlorides, oxides, and other post-manufacturing cleaning products which allows for corrosion from the inside. Additionally, if the concrete contains structural steel (for increased strength) these natural events will eventually penetrate the concrete (which also increases the concrete Ph over time) to the steel, thereby accelerating the corrosion. Over time, the steel will continue to corrode to the point where it starts to expand (corroded steel has typically 2-3 times more volume than non-corroded steel). This expansion will result in an increase in the internal stresses within the concrete. These increased stresses will eventually cause the concrete to crack, allowing even more water, salt etc. to penetrate and accelerate the rate of deterioration. Concrete maintenance is expensive over time and, if not performed, will result in a significantly lower life span. Also, by eliminating the steel from corroding, one of the primary causes of catastrophic events for concrete projects can be significantly reduced or eliminated. In addition, often not all of the concrete used in a large construction project needs to be structural grade strength. Examples include but not limited to floors, roofs, non-load bearing exterior walls, etc. Using 100% structural strength concrete results in a project that will require larger structural components for the ground and lower floors to support the additional weight, which compounds itself the larger the project. The increased weight requires additional concrete and structural steel which increases project cost, CO₂ emissions due to the additional cement, steel, and transportation requirements. Traditional methods to address this issue typically look at a single failure mechanism.

### BRIEF DESCRIPTION

Disclosed, in some embodiments, is a three-step method for forming a hybrid building system (HBS). Step 1 uses an environmentally friendly laser ablation system to eliminate any pre-existing contaminants (e.g., chlorides, oxides, surface rust) from the structural element. This is a critical first step to maximize the effectiveness of the multiple step HBS process. Typically, any remaining surface contamination can cause an attack from the surface outward as well as inward and will result in a lower level of effectiveness of the HBS system. For the three-step HBS method, step 2 applies a graphene-enhanced coating system. This coating system is selected for the specific structural element used for the project and will eliminate or greatly reduce the ability of environmental elements to attack the structural element from the outside in. Step 3 includes pouring a graphene-enhanced concrete system to encase the structural element in a concrete having improved water-resistance and increased strength compared to traditional concrete. In addition to the Graphene used in step 3 other additives can also be included to provide additional specific properties such cellular foaming agents as well as other admixtures.

Disclosed, in other embodiments, is a four-step HBS method. The first three steps are as described in the preceding paragraph. In step 4, another graphene-enhanced coating can be applied for additional protection for applications with specific environmental and increased resilience needs.

Disclosed, in some embodiments, is a method including in sequence: laser ablating a structural element to remove surface contamination; applying a graphene-enhanced coating to the structural element; and encasing the structural element in a graphene-enhanced primary building material.

In some embodiments, the method further includes applying an external coating after the encasing.

The external coating may be a graphene-enhanced coating.

In some embodiments, the graphene-enhanced primary building material further includes a cellular foam.

The encasing may include pouring the graphene-enhanced primary building material.

In some embodiments, the encasing includes additive manufacturing.

The graphene-enhanced primary building material may include concrete.

In some embodiments, the structural element includes steel.

The graphene-enhanced coating may have a thickness of up to 150 mils.

In some embodiments, the graphene-enhanced coating has a thickness in a range of about 2 mils to about 8 mils.

The structural element may include structural steel.

In some embodiments, the structural element includes one or more materials selected from titanium, titanium alloys, stainless steel, iron, iron alloys, nickel, nickel alloys, aluminum, aluminum alloys, concrete, and plastic.

The substrate may include one or more elements selected from the group consisting of lithium, beryllium, sodium, magnesium, aluminum, potassium, calcium, scandium, titanium, vanadium, chromium, manganese, iron, cobalt, nickel, copper, zinc, gallium, Rb, strontium, yttrium, zirconium, niobium, molybdenum, technetium, ruthenium, rhodium, palladium, silver, cadmium, indium, tin, cesium, barium, lanthanum, cerium, praseodymium, neodymium, promethium, samarium, europium, gadolinium, terbium, dysprosium, holmium, erbium, thulium, ytterbium, lutetium, hafnium, tantalum, tungsten, rhenium, osmium, iridium, platinum, gold, thallium, lead, bismuth, polonium, francium, radium, actinium, thorium, protactinium, neptunium, plutonium, americium, curium, berkelium, californium, einsteinium, fermium, mendelevium, nobelium, lawrencium, rutherfordium, dubnium, seaborgium, bohrium, hassium, meitnerium, darmstadtium, roentgenium, copernicium, nihonium, flerovium, livermorium, boron, silicon, germanium, arsenic, antimony, and tellurium.

In some embodiments, the laser ablation is performed with a Q-switched, neodymium-doped yttrium aluminum garnet laser.

The laser may have a pulse frequency in a range of 10 kHz to 25 KHz.

In some embodiments, the external coating has a thickness of up to 150 mils.

The external coating may have a thickness in a range of about 2 mils to about 8 mils.

In some embodiments, the graphene-enhanced primary building material contains graphene and concrete in combination with at least one of a water reducing agent, a superplasticizer, an air entrainer, and/or a pumping agent.

In some embodiments, the graphene-enhanced primary building material contains graphene and concrete in combination with at least one of a set retarder, an early strength agent, and early strength water reducing agent, a set accelerator, a pumping agent, and/or a pozzolanic admixture.

In some embodiments, the graphene-enhanced primary building material contains graphene and concrete in combination with at least one of a gas forming agent, an air entrainer, a water-repellant admixture, and/or an alkali-silica reactivity inhibitor.

In some embodiments, the graphene-enhanced primary building material contains graphene and concrete in combination with at least one of a gas forming agent, an air entrainer, and/or a defoamer.

In some embodiments, the graphene-enhanced primary building material contains graphene and concrete in combination with at least one of a shrinkage reducing admixture, an expanding agent, an anti-freezing admixture, a curing agent, a coloring admixture, and/or an underwater concrete anti-dispersant.

In some embodiments, the graphene-enhanced primary building material contains graphene and concrete in combination with at least one of a mold release agent, a damp proofing admixture, a concrete acteriostatic agent, an anti-corrosion admixture, and an adhesive bonding admixture.

The graphene-enhanced primary building material may further include at least one of fly ash, slag, silica fume and other natural pozzolans.

Disclosed, in other embodiments, is a method for coating a non-structural element. The method includes applying a composition containing a cellular foam to the non-structural element.

These and other non-limiting characteristics are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a flow chart illustrating a three-step method in accordance with some embodiments of the present disclosure.

FIG. 2 is a flow chart illustrating a four-step method in accordance with some embodiments of the present disclosure.

FIG. 3 is a side, cross-sectional view of a coated system in accordance with some embodiments of the present disclosure.

### DETAILED DESCRIPTION

The present disclosure may be understood more readily by reference to the following detailed description of desired embodiments included therein. In the following specification and the claims which follow, reference will be made to a number of terms which shall be defined to have the following meanings.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent can be used in practice or testing of the present disclosure. All publications, patent applications, patents, and other references mentioned herein are incorporated by reference in their entirety. The materials, methods, and articles disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases that require the presence of the named ingredients/steps and permit the presence of other ingredients/steps. However, such description should be construed as also describing compositions, mixtures, or processes as “consisting of” and “consisting essentially of” the enumerated ingredients/steps, which allows the presence of only the named ingredients/steps, along with any impurities that might result therefrom, and excludes other ingredients/steps.

The methods of the present disclosure lead to reduced maintenance, repair, and operation costs. Construction costs may be reduced since less material may be used. Moreover, graphene-enhanced concrete is stronger and more resistant to water than traditional concrete. The methods may be applicable to traditional or additive manufacturing (e.g., 3D printing) construction projects.

The Hybrid Building System (HBS) of the present disclosure is cost-effective, environmentally friendly, and durable. The HBS is better at resisting water and other external contaminant penetration, corrosion, and cracking with reduced maintenance and increased design life over existing concrete building products. The HBS can be used with or without “Cellular Foam” and/or other additives that can produce a variety of specialized properties, including but not limited to lighter weight, higher thermal resistance, and electrical conductivity.

The HBS addresses many of the issues associated with current commercial concrete systems. First, in every manufacturing process the product surface contains a variety of contaminants such as but not limited to; chlorides, oxides, and other solvents used in both the manufacturing as well as post manufacturing cleaning process. In addition, in current commercial structurally enhanced concrete, the low-grade steel typically used in this application has already started to corrode prior to using it. The first step of the HBS process for those concrete projects that require steel or structural member of any kind is to use an environmentally friendly laser ablation system to eliminate any external contaminants on the structural surface of the element (often steel or similar type materials are used but not limited to) by vaporizing them. Surface contaminants such as oxides, chlorides, corrosion, etc. that have accumulated during manufacturing, transportation process will be removed. For non-structural concrete, the structural element is often not included, so this step can be eliminated for these applications. The second step of the HBS process is to apply a graphene-enhanced coating to the structural element (if used; often steel or similar materials are used but the present disclosure is not limited thereto) to keep any moisture from coming into contact with the structural element and thereby, eliminating the initiation of the corrosion and other life limiting processes. For non-structural concrete, the structural element is often not included, so this step can be eliminated for these applications. The third step of the HBS process is to enhance the primary building material (often concrete or similar material is used but not limited to) with graphene, then combine the graphene-enhanced primary building material with the graphene-enhanced coated structural element (if used) following standard approved commercial processes. Graphene has shown to increase the strength of a variety of construction materials (such as but not limited to concrete, asphalt, plastics, etc.) as well as reduce water penetration over non-graphene enhanced materials. Due to the increased strength of the graphene-enhanced primary building material (often concrete or similar materials are used but not limited thereto), less structural element material (if used) is needed as compared to the same primary building material and structural element without graphene. For non-structural concrete applications, in addition to the graphene, a cellular foam additive can be added. The combination of the cellular foam and graphene result in a stronger, more environmentally resilient concrete system that is lighter, has increased resistance to water penetration, thermal resistance, and (if needed) electrical conductivity as well as a reduced noise transmission compared to traditional concrete formulations. A fourth step (optional) includes a variety of external/top coatings that can be used for a variety of purposes such as but not limited to; enhanced durability, reduced maintenance and/or improved visual appearance. The expected return on any up-front investment will be more than off-set by the reduced maintenance and increased usable lifespan of the project.

Non-limiting examples of construction projects that may utilize of the HBS methods of the present disclosure includes commercial buildings, bridges, seawalls, houses, roads, airport runways, or any project that uses concrete as the primary building material.

Construction projects that use the HBS will be more durable, need less maintenance, and last considerably longer than the same projects that using non-processed structural elements (if used) and non-graphene primary building materials. Therefore, on a life cycle cost basis, HBS projects will be less costly than the same projects that use non-processed structural elements (if used) and non-graphene primary building materials. By keeping the structural element (if used) from contacting the environmental elements, one of the primary causes of catastrophic events for concrete projects can be significantly reduced or eliminated. For those concrete projects that do not require a structural strength HBS concrete system formulation, there is an alternative HBS formulation. This alternative HBS formulation employs a cellular foam additive along with the graphene (a structural element may also be added if required) to reduce weight, increase resistance to water penetration, improve thermal resistance, improve electrical conductivity, reduce noise transmission, and improve overall environmental resiliency.

The HBS method is a versatile, multi-step process that significantly improves the durability compared the same projects that use non-processed structural elements (if used) and non-graphene enhanced primary building materials. The first step of the HBS process is to use an environmentally friendly laser ablation system to eliminate any external contaminants on the structural element (if used; often steel or similar type materials are used but the present disclosure is not limited thereto) by vaporizing them. Surface contaminants such as oxides, chlorides, corrosion, etc. that may have accumulated during manufacturing, transportation process will be removed. The second step of the HBS process is to apply a graphene-enhanced coating to the structural element (if used; often steel or similar type materials are used but not limited to) that is typically placed in the interior of the HBS to keep any moisture and other elements from coming into contact with the structural element and thereby eliminating the initiation of corrosion or other life limiting processes. The third step of the HBS process is to enhance the primary building material (often concrete or similar materials are used but not limited to) with graphene, then combine the graphene-enhanced primary building material with the graphene-enhanced coated structural element (if used) following using standard approved commercial concrete processes with or without including a cellular foam” additive, typically used for non-structural purposes processes which reduce weight, increase resistance to water penetration, improve thermal resistance, improve electrical conductivity, reduce noise transmission, and improve overall environmental resiliency, etc. A fourth step (optional) includes a variety of external/top coatings applied to the outside of the HBS to provide even more protection over the baseline HBS from natures worst elements for even better durability, reduced maintenance and/or improved visual appearance.

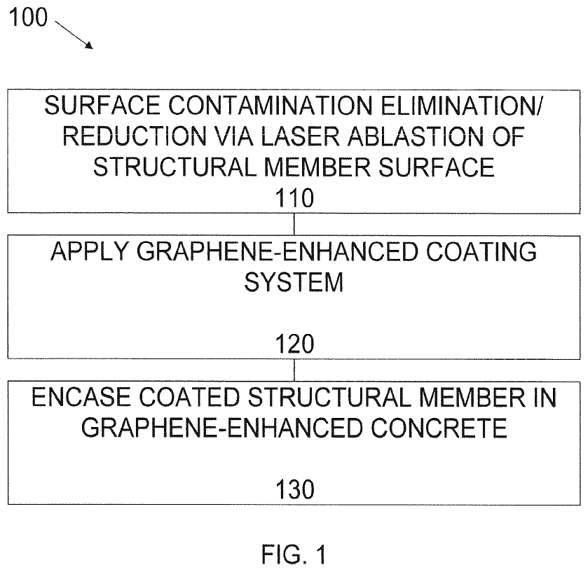

FIG. 1 is a flow chart illustrating a three-step method 100 in accordance with some embodiments of the present disclosure.

In a first step 110, laser ablation is utilized to remove surface contaminants from a structural element. Use the environmentally friendly laser ablation process to clean the structural element may reduce or completely eliminate any surface contamination on the structural element. This step reduces or eliminates any potential coating attack coming from underneath the subsequently applied coating. Selection of the laser ablation system is important to ensure that during the laser ablation process no substrate surface micro melting occurs as this would likely have a negative impact on the strength of the object being cleaned. In some non-limiting embodiments, laser ablation is performed using a q-switched, neodymium-doped yttrium aluminum garnet laser. The laser may have a pulse frequency in a range of about 10 kHz to about 25 KHz.

Non-limiting examples of structural element substrate materials include titanium, titanium alloys, stainless steel, iron, iron alloys, nickel, nickel alloys, aluminum, aluminum alloys, and non-metallics (e.g., concretes, plastics, and composite materials). In some embodiments, the substrate contains elemental metal, an elemental metalloid, or an alloy containing one or more metal elements and/or one or more metalloid elements. Non-limiting examples of such elements include lithium, beryllium, sodium, magnesium, aluminum, potassium, calcium, scandium, titanium, vanadium, chromium, manganese, iron, cobalt, nickel, copper, zinc, gallium, Rb, strontium, yttrium, zirconium, niobium, molybdenum, technetium, ruthenium, rhodium, palladium, silver, cadmium, indium, tin, cesium, barium, lanthanum, cerium, praseodymium, neodymium, promethium, samarium, europium, gadolinium, terbium, dysprosium, holmium, erbium, thulium, ytterbium, lutetium, hafnium, tantalum, tungsten, rhenium, osmium, iridium, platinum, gold, thallium, lead, bismuth, polonium, francium, radium, actinium, thorium, protactinium, neptunium, plutonium, americium, curium, berkelium, californium, einsteinium, fermium, mendelevium, nobelium, lawrencium, rutherfordium, dubnium, seaborgium, bohrium, hassium, meitnerium, darmstadtium, roentgenium, copernicium, nihonium, flerovium, livermorium, boron, silicon, germanium, arsenic, antimony, and tellurium.

In particular embodiments, the substrate includes structural steel.

In a second step 120, a graphene-enhanced coating is applied to the laser-ablated surface. This coating prevents moisture from coming into contact with the surface, thereby eliminating one of the primary causes of structural concrete maintenance issues and catastrophic events. The graphene content may be in a range of about 0.5 to about 5 wt%. The graphene content depends on the specific application and desired properties, such as mechanical (e.g., corrosion/rust inhibition), thermal, and electrical properties.

In non-limiting embodiments, the graphene-enhanced coating is applied via Airless spraying and/or manually using Brush or Roller.

The graphene-enhanced coating may further include an epoxy. In some embodiments, the epoxy is a multi-component epoxy system with 1 to 3 separate coatings that also may include but not limited to, epoxy, polyurethane, fluorourethane, polysiloxane, aluminum, zinc, and aggregate such as, but not limited to, sand, etc.

Wet application thicknesses range considerably depending on the specific application such as but not limited to; 2-8 mils for a limited environmental exposure applications and up to 150 mils or even thicker under certain applications.

In a third step 130, the coated element is combined with a graphene-enhanced primary building material. The graphene content may be in a range of about 0.5 to about 5 wt%. The graphene content depends on the specific application and desired properties, such as mechanical (e.g., corrosion/rust inhibition), thermal, and electrical properties. A cellular foam additive may also be combined with these materials. When present, the foam additive content may be in a range of about 0.5 to about 5 wt% and depends on the specific mechanical (e.g., strength, weight, water and thermal resistance, electrical conductivity) properties required for the application.

In some embodiments, the concrete admixture includes a water reducing agent (e.g., an ordinary water reducing agent), a superplasticizer, an air entrainer, and/or a pumping agent. This admixture may improve the performance of the concrete mixture.

In some embodiments, the concrete admixture includes a set retarder, an early strength agent, and early strength water reducing agent, a set accelerator, a pumping agent, and/or a pozzolanic admixture. This admixture may adjust the concrete setting time and hardening performance.

In some embodiments, the concrete admixture includes a gas forming agent, an air entrainer, a water-repellant admixture, and/or an alkali-silica reactivity inhibitor. This admixture may improve concrete durability.

In some embodiments, the concrete admixture includes a gas forming agent, an air entrainer, and/or a defoamer. This admixture may adjust the air content of the concrete.

In some embodiments, the concrete admixture includes a shrinkage reducing admixture, an expanding agent, an anti-freezing admixture, a curing agent, a coloring admixture, and/or an underwater concrete anti-dispersant. This admixture may provide special properties to the concrete.

In some embodiments, the concrete admixture includes a mold release agent, a damp proofing admixture, a concrete acteriostatic agent, an anti-corrosion admixture, and an adhesive bonding admixture.

In addition to the admixtures listed above there are other materials such as but not limited to; fly ash, slag, silica fume and other natural pozzolans that can be applied to standard concrete mixtures to reduce cost, increase strength, permeability, etc.

The cellular foam concrete typically includes a solution of surfactants which when used with a foam generator and acceptable water source produce a pre-foam solution that can be mixed directly (but alternative options are also available) in the concrete mixing truck drum. The cellular concrete typically has good flow characteristics and can use standard concrete on sight delivery methods. The amount of cellular foaming agent depends on the required strength of the foam concrete for the specific application. The typical range of concrete foam density is 20 to 100 lb/ft³, but can also lie outside of this range depending on the specific application. An example of an existing commercial concrete cellular foam agent is FLO-CF from Premiere Concrete Admixtures.

Graphene improves strength and reduces water penetration over similar non-graphene enhanced building material. Due to the increased strength of the graphene-enhanced primary building material, a reduced amount of structural component (if used) may be needed as compared to the same project that uses non-processed structural elements and non-graphene primary building materials. An alternative non-structural HBS formulation that typically does not use a structural element also employs a cellular foam additive that results in a reduced weight, increased resistance to water penetration, improved thermal resistance, improved electrical conductivity, reduced noise transmission, and improved overall environmental resiliency, etc.

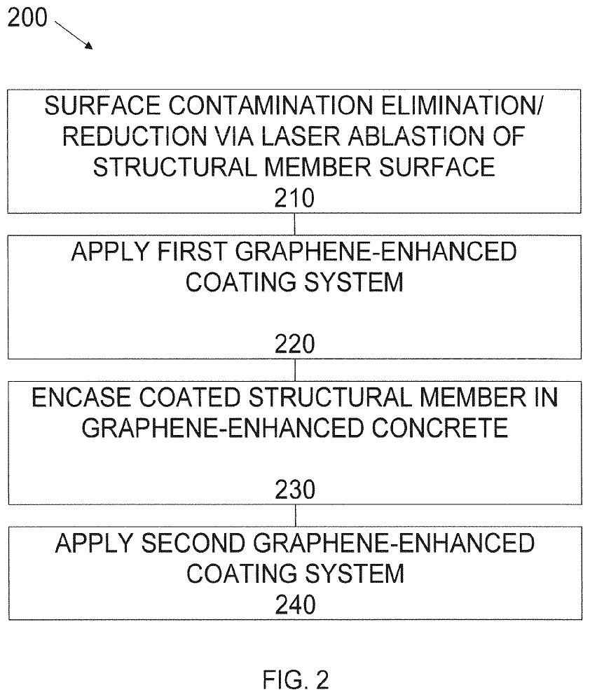

FIG. 2 is a flow chart illustrating a four-step method 200 in accordance with some embodiments of the present disclosure. The first step 210, second step 220, and third step 230 of the process 200 may be the same as the steps 110, 120, 130 of the three-step method 100 of FIG. 1.

In a fourth step 240, an external coating is applied to provide additional protection from environmental conditions. The external coating (which may be a graphene-enhanced coating) provides even more protection over the baseline HBS from natures worst elements.

Each step resolves specific issues and the steps in combination are synergistic. The first step is beneficial when a structural element of some form is included in the concrete in order to completely eliminate any surface contamination that can lead to corrosion or similar attacks on the structural element. The second step ensures that the internal structural element is encased in a graphene-enhanced coating to eliminate any possibility of corrosion or similar attack coming from the outside. Now natural elements can no longer attack the structural element from either the inside or the outside. The third step enhances the primary building material with graphene to increase strength and significantly reduce the penetration of water, salt, and other chemicals into the primary building material for increased durability. The last part of the third step is to combine the graphene coated structural element with the graphene enhanced building material with or without a cellular foam and/or other specialized additives together following standard approved commercial manufacturing processes. The optional fourth step applies an additional external/top coat to the outside of the HBS to provide even more protection over the baseline HBS from natures worst elements.

The laser ablation process leaves the surface contamination free while other cleaning processes will leave other surface contaminants.

The laser ablation process is environmentally friendly compared to other surface cleaning processes.

The graphene-coated structural element is unique to the construction industry.

Graphene-enhanced concrete is not currently used in the commercial construction industry.

Cellular foam additives combined with graphene provide a unique lighter weight, higher thermal resistance and electrical conductivity, reduced noise transmission as well as improved environmental resiliency is unique to the construction industry.

The combination of the laser ablated structural element, graphene-enhanced coating applied to the structural element, and graphene-enhanced primary building materials is unique to the construction industry.

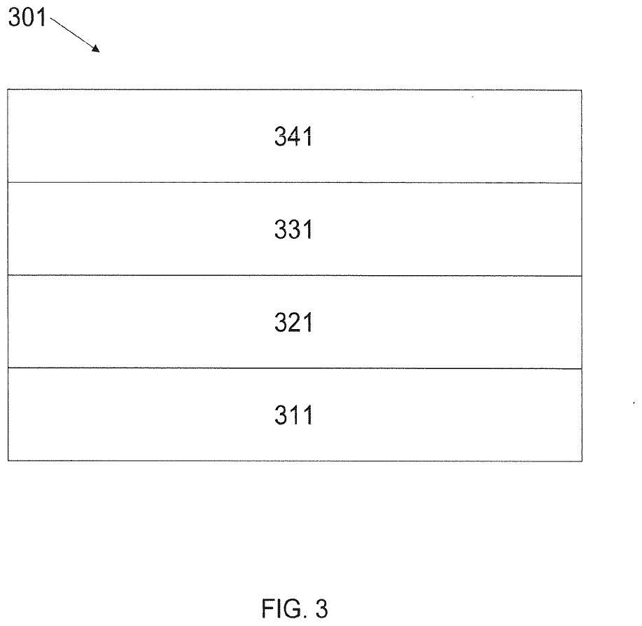

FIG. 3 is a side, cross-sectional view of a coated system 301 in accordance with some embodiments of the present disclosure. The system 301 includes a substrate 311, a graphene-enhanced coating 321, a graphene-enhanced building material layer 331, and optionally a protective layer 341. The protective layer 341 may be a second graphene-enhanced coating layer.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An HBS method comprising in sequence:
laser ablating a structural element to remove surface contamination;
applying a graphene-enhanced coating to the structural element; and
encasing the structural element in a graphene-enhanced primary building material.

2. The HBS method of claim 1, further comprising:
applying an external coating after the encasing.

3. The HBS method of claim 2, wherein the external coating is a graphene-enhanced coating.

4. The HBS method of claim 1, wherein the graphene-enhanced primary building material further comprises a cellular foam.

5. The HBS method of claim 4, wherein the encasing comprises pouring the graphene-enhanced primary building material.

6. The HBS method of claim 1, wherein the encasing comprises additive manufacturing.

7. The HBS method of claim 1, wherein the graphene-enhanced primary building material comprises concrete.

8. The HBS method of claim 1, wherein the structural element comprises steel.

9. The HBS method of 8 claim 1, wherein the graphene-enhanced coating has a thickness of up to 150 mils.

10. (canceled)

11. (canceled)

12. The HBS method of claim 1, wherein the structural element comprises one or more materials selected from the group consisting of: titanium, titanium alloys, stainless steel, iron, iron alloys, nickel, nickel alloys, aluminum, aluminum alloys, concrete, and plastic.

13. The HBS method of claim 1, wherein the substrate comprises one or more elements selected from the group consisting of lithium, beryllium, sodium, magnesium, aluminum, potassium, calcium, scandium, titanium, vanadium, chromium, manganese, iron, cobalt, nickel, copper, zinc, gallium, rubidium, strontium, yttrium, zirconium, niobium, molybdenum, technetium, ruthenium, rhodium, palladium, silver, cadmium, indium, tin, cesium, barium, lanthanum, cerium, praseodymium, neodymium, promethium, samarium, europium, gadolinium, terbium, dysprosium, holmium, erbium, thulium, ytterbium, lutetium, hafnium, tantalum, tungsten, rhenium, osmium, iridium, platinum, gold, thallium, lead, bismuth, polonium, francium, radium, actinium, thorium, protactinium, neptunium, plutonium, americium, curium, berkelium, californium, einsteinium, fermium, mendelevium, nobelium, lawrencium, rutherfordium, dubnium, seaborgium, bohrium, hassium, meitnerium, darmstadtium, roentgenium, copernicium, nihonium, flerovium, livermorium, boron, silicon, germanium, arsenic, antimony, and tellurium.

14. The HBS method of claim 1, wherein the laser ablation is performed with a Q-switched, neodymium-doped yttrium aluminum garnet laser.

15. The HBS method of claim 14, wherein the laser has a pulse frequency in a range of 10 kHz to 25 KHz.

16. The method of claim 2, wherein the external coating has a thickness of up to 150 mils.

17. (canceled)

18. The method of claim 1, wherein the graphene-enhanced primary building material comprises graphene and concrete in combination with at least one of a water reducing agent, a superplasticizer, an air entrainer, and/or a pumping agent.

19. The method of claim 1, wherein the graphene-enhanced primary building material comprises graphene and concrete in combination with at least one of a set retarder, an early strength agent, and early strength water reducing agent, a set accelerator, a pumping agent, and/or a pozzolanic admixture.

20. The method of claim 1, wherein the graphene-enhanced primary building material comprises graphene and concrete in combination with at least one of a gas forming agent, an air entrainer, a water-repellant admixture, and/or an alkali-silica reactivity inhibitor.

21. The method of claim 1, wherein the graphene-enhanced primary building material comprises graphene and concrete in combination with at least one of a gas forming agent, an air entrainer, and/or a defoamer.

22. The method of claim 1, wherein the graphene-enhanced primary building material comprises graphene and concrete in combination with at least one of a shrinkage reducing admixture, an expanding agent, an anti-freezing admixture, a curing agent, a coloring admixture, and/or an underwater concrete anti-dispersant. cm 23. The method of claim 1, wherein the graphene-enhanced primary building material comprises graphene and concrete in combination with at least one of a mold release agent, a damp proofing admixture, a concrete acteriostatic agent, an anti-corrosion admixture, and an adhesive bonding admixture; and/or wherein the graphene-enhanced primary building material further comprises at least one of fly ash, slag, silica fume and other natural pozzolans.

24. (canceled)

25. (canceled)
